(19) United States
(12) Patent Application Publication
(10) Pub. No.: US 2014/0085717 A1
(43) Pub. Date: Mar. 27, 2014

(54) SYSTEMS AND METHODS FOR CLOSED-LOOP TELESCOPE CONTROL

(71) Applicants: KENNETH W. BAUN, Trabuco Canyon, CA (US); John E. Hoot, San Clemente, CA (US)

(72) Inventors: KENNETH W. BAUN, Trabuco Canyon, CA (US); John E. Hoot, San Clemente, CA (US)

(21) Appl. No.: 13/624,687

(22) Filed: Sep. 21, 2012

(51) Int. Cl. G02B 23/00

(52) U.S. Cl. CPC G02B 23/00
USPC 359/429

(57) ABSTRACT

A closed-loop telescope control system is disclosed that greatly improves the accuracy of telescope operation. Using image information collected by sensors mounted on the telescope, a control system can improve pointing accuracy by observing the actual position of a selected object and making minute pointing corrections. Tracking accuracy is greatly improved using image information to directly control servo motor operation by a telescope control. Additional automated features are possible by the closed-loop capacity of the disclosure to improve the efficiency of a telescope system.

### CROSS-REFERENCE TO RELATED APPLICATIONS

This application claims the benefit of PPA Ser. No. 61/539,848, filed 2012 Sep. 27 by Lenora Cabral, which is incorporated by reference. This application uses the frammis vane disclosed in U.S. Pat. No. 7,482,564, granted 2009 Jan. 27, which is incorporated by reference.

### BACKGROUND OF THE INVENTION

The following is a tabulation of some prior art that presently appears relevant:

### U.S. Patents

| Pat. No. | Kind Code | Issue Date | Patentee |
|---|---|---|---|
| 4,682,091 | — | 1987 JUL 21 | Krewalk et al. |
| 4,944,587 | — | 1990 JUL 31 | Harigae |
| 5,223,702 | — | 1993 JUN 29 | Conley |
| 5,311,203 | — | 1994 MAY 10 | Norton |
| 5,365,269 | — | 1994 NOV 15 | Holmes et al. |
| 5,525,793 | — | 1996 JUN 11 | Holmes et al. |
| 5,745,869 | — | 1998 APR 28 | Van Bezooijen |
| 5,935,195 | — | 1999 AUG 10 | Quine |
| 6,056,554 | — | 2000 MAY 2 | Samole |
| 6,304,376 | B1 | 2001 OCT 16 | Baun et al. |
| 6,366,212 | B1 | 2002 APR 2 | Lemp |
| 6,369,942 | B1 | 2002 APR 9 | Hedrick et al. |
| 6,392,799 | B1 | 2002 MAY 21 | Baun et al. |
| 6,563,636 | B1 | 2003 MAY 13 | Baun et al. |
| 6,603,602 | B1 | 2003 AUG 5 | McWilliams |
| 6,671,091 | B2 | 2003 DEC 30 | McWilliams |
| 6,922,283 | B2 | 2005 JUL 26 | Baun et al. |
| 6,972,902 | B1 | 2005 DEC 6 | Chen et al. |
| 7,046,438 | B2 | 2006 MAY 16 | McWilliams |
| 7,068,180 | B2 | 2006 JUN 27 | Lemp |
| 7,079,317 | B2 | 2006 JUL 18 | Baun et al. |
| 7,092,156 | B2 | 2006 AUG 15 | Baun et al. |
| 7,221,527 | B2 | 2007 MAY 22 | Baun et al. |
| 7,339,731 | B2 | 2008 MAR 4 | Baun et al. |
| 7,482,564 | B2 | 2009 JAN 27 | Baun et al. |
| 7,518,792 | B2 | 2009 APR 14 | McWilliams |

### U.S. Patent Application Publications

| Publication Number | Kind Code | Publication Date | Applicant |
|---|---|---|---|
| 2003/0197930 | A1 | 2003 OCT 23 | Baun et al. |
| 2009/0195871 | A1 | 2009 AUG 6 | McWilliams |

### Nonpatent Literature Documents

W. M. Smart, Textbook on Spherical Astronomy, sixth edition, Cambridge University Press, 1977. cited by other.
Richard T. Fienberg, Sky & Telescope Magazine, “You Get What You Pay For” (October 2006, page 8)
Dennis di Cicco, Sky & Telescope Magazine, “The Telescope Drive Master”, (October 2011, page 60-63)
Patrick Wallace, “Telescope Pointing”, Tpoint Software Webpage, 1998-2010, (http://www.tpsoft.demon.co.uk/pointing.htm)

### FIELD OF THE INVENTION

The present disclosure relates to telescope control systems and, more particularly, to systems and methods for aligning, orienting, tracking and removing errors from telescope operation.

### DESCRIPTION OF RELATED ART

From the first invention of the telescope, two important related activities were necessary. Pointing the telescope accurately at a selected object and following it as it moves. At first, this was accomplished by the using the eye/hand coordination of the observer pointing the telescope at the object and following it based on visual cues. This is still true today when using small handheld optics like binoculars.

As telescopes became larger and optically powerful, it became difficult or impossible to even hold much less point accurately in any particular direction. As a result, telescope mounts were invented to hold the telescope and assist the observer in moving the main optic to a desired position. Operation of those telescopes was completely manual. Celestial objects were located by having knowledge of the sky and patterns of stars. Once an object was located, the observer would continuously move the telescope to follow it as the Earth rotated.

Telescope mounts were then invented with “clock drives” which automatically followed the “moving sky”. A “clock drive” moves one axis of a telescope mount at the same rate as the rotation of Earth. When the rotating mount axis is aligned parallel to the Earth's axis of rotation, the telescope and sky became synchronized. Stars and other celestial objects appear not to move in the view of the telescope. These clock drives were an improvement but they had limitations. If the rate of movement was not exactly matched to Earth's rotation objects would slowly drift out of sight. If gears in the drive had uneven surfaces objects would move about in the field of view.

Recent rapid advances in technology have made possible telescopes with greater control and motion capabilities. Servo motors with encoders and control systems have been added that allow telescopes greater capabilities in pointing toward selected regions of the sky. Very accurate timing circuits also result in greater accuracy in tracking than previous clock drives. With all of these advances the telescope systems still contained imperfections and remained dependant on human feedback to perfect pointing and tracking. An observer would need to view a selected object in his optical system and make corrections to center or track an object to the precision required. The pointing and tracking errors came form multiple sources. Crystals would drift with temperature causing errors in movement rates. Gears would have minute imperfections that cause momentary changes to speed or position. The structure of the telescope mount would shift as the weight of portions of the telescope move to new positions. Parts of the mount or even the surface on which the telescope rested would deform differently as the mount shifted weight.

These new control systems also had the capability to be aligned with the sky. Alignment meant the control system could establish a known relationship of a position in the sky with the internal position sensors for the telescope. When a telescope would attempt to locate and track an object it would use the motor/encoder system to orient the telescope to a position that pointed in the direction of the object. Since the telescope control system could not actually see the object, it is often referred to as “blind pointing”. It is like reaching for a light switch in a dark room in the area you expect to find it. Control engineers also call this “open loop” control. While the controller has some feedback about position and motor speed, it does not have direct feedback about the actual pointing position in the sky other than what is implied by internal encoders or sensors. This method of control is described in U.S. Pat. Nos. 4,682,091, 6,369,942 and 6,392,799.

As electronic instruments were added to telescope systems greater demands were placed on pointing and tracking accuracy. Image sensors used for photography often small and have very high resolution. Placing an object which is often nearly invisible onto the small sensor becomes a very time consuming and difficult operation with poor telescope pointing accuracy. Tracking also becomes critical when high quality detailed imaging was needed. Small uneven movements in the telescope can smear and distort the image. These errors come from many sources and are often not detectable by the telescope control system through the internal position sensors. Another very demanding instrument used on a telescope is a slit spectrometer. Placing the image of a small celestial object on the slit and maintaining that position is very difficult. For most simple controllers it is not possible without the aid of some manual intervention by the operator.

Pointing errors may result from many sources. One source is misalignment to the sky where the telescope position sensors are not synchronized to the present sky. This might be small if an alignment star is not properly centered. A very large error could also result from selecting the wrong alignment stars. Other sources of error can be introduced by mechanical part or assembly imperfections. If the two rotating axis of the telescope are not perpendicular, angular displacements during movement will go undetected by the control system sensors. Irregularities in the gears used to move the axes will introduce errors. Weight induced flexure in the mechanical structures of the telescope will change pointing direction during movements. The atmosphere can change the apparent visual location of an object by refracting the light. This happens at lower elevations near the horizon or from atmospheric disturbances like turbulence. Errors in time can accumulate and change pointing accuracy as celestial time and internal telescope time drift apart. All of these errors and more will accumulate and add to the pointing error of a telescope. Many of these errors are undetectable directly by the telescope control and internal position sensors.

Sources of tracking errors are also many and varied. Gear tooth irregularity can be seen in uneven movements. Most of this is called periodic error because it repeats and returns to a starting position. Alignment errors can cause drift in a particular direction as can telescope axes that are not perpendicular. Time inaccuracies will also cause drift as error accumulates. Atmospherics will also affect tracking as an object moves down toward the horizon or as temperature and humidity change. These mechanisms and more will combine to create tracking irregularities. They are also undetectable to the telescope control and internal position sensors.

Many solutions have been employed to correct for these errors. Many involve the direct participation of an observer who intervenes with the telescope operation to affect a correction. This can also include a training activity where errors are anticipated and blindly corrected because they are expected. This is done for most periodic error and can also be done for flexure to the degree that it is repeatable. High precision encoders are also used at telescope axes which can detect gear irregularities and facilitate corrections in the control system. All of these methods can detect some portions of the total error but not all. Many of these corrections are done by blind control since the actual error is only anticipated and not directly detected.

Other attempts to automate error correction involve the use of an electronic interface called an “autoguider port” which is a telescope industry standard. It provides for signal inputs to move a telescope up, down, right and left for the duration of an applied signal. This port was originally utilized by an electronic imaging device, the autoguider, which would observe the location of a reference star and send signals to the telescope using the autoguider port. The autoguider would initially need to be calibrated with the telescope to determine how much movement is accomplished for a given duration of signal as well as the direction of travel. Once calibration was complete, error correction could be attempted for tracking errors (not pointing errors) by sending signals to the autoguider port. These movements were only helpful if the telescope was accurately calibrated and movements were consistent with calibration.

While the autoguider eliminated many tedious hours of manual operation it still had weaknesses which were inherent in the system or resulted from the very low level interface available using the autoguider port. For example, pointing corrections are not possible because only small adjustments can be achieved in a limited region of the sky. The accuracy of guiding is determined by the affect of the duration of a signal on the motor movement and the speed. Some errors that are large or rapidly changing may not be correctable with the available guide speeds. This would include large flexure or rapid atmospherics. Equipment other than autoguiders also use the standard autoguider port to make error corrections. This includes the high precision axis encoders mentioned previously. These correct for gear irregularities by making small corrections indicated by movements at each axis encoder.

All of these correction methods fall short of a complete solution to pointing and tracking. They are either unable to detect certain errors or are unable to communicate accurately the actual position of the celestial object under the influence of the error source.

### BRIEF DESCRIPTION OF THE DRAWINGS

Systems and methods which embody the various features of the disclosure will now be described with reference to the following drawings:

FIG. 1 is a perspective view of the imager device of a closed-loop telescope control according to the embodiment of the disclosure.

FIG. 2 is an exploded view of the imager device of a closed-loop telescope control showing individual components used in a possible embodiment of FIG. 1.

FIG. 3 is a block diagram of a closed-loop telescope control system according to the embodiment of the disclosure.

FIG. 4 is a perspective view of an exemplary telescope that is operated by the closed-loop telescope control system according to the embodiment of the disclosure.

FIG. 5 is an exemplary graphical representation of a celestial hemisphere used in object identification and observational processes according to an embodiment of the disclosure.

### DETAILED DESCRIPTION

Embodiments of the present disclosure involve a telescope control system with imaging capability to facilitate or modify telescope operation by the visual information collected. This is commonly referred to as closed-loop control. Appropriate imaging data needed to perform a particular operation may require multiple imaging channels or the ability to adjust a single channel. For example, data from a wide-field image may be useful in telescope alignment or pointing operations. A narrow-field image with higher resolution will provide the additional data to make very fine adjustments or measurements in other operations. The number or type of channels needed is not restricted in this disclosure and may be defined as appropriate for a particular function or available technology.

To orient the telescope, certain embodiments of the telescope control system point the telescope in the direction of an alignment star or alignment area of the sky. The telescope control system images an appropriate field of view in the alignment area, and processes the images to determine the celestial coordinates of a point such as a center of the field of view the alignment area. The telescope control system then maps the telescope's coordinate system to the celestial coordinate system. Once mapped, the telescope control system can advantageously slew the telescope to any desired celestial object in the viewable sky based on, for example, user selection, system recommendations, combinations of the same, or the like.

In certain embodiments, the telescope control system seeks to improve the accuracy of the foregoing self alignment procedure. For example, the telescope control system may advantageously slew to an additional alignment area and realign, may advantageously measure the drift of one or more alignment stars or the desired celestial object, combinations of the same, or the like. Or it may use the imaging device to make added corrections upon moving to a new area of the sky.

In certain embodiments, the telescope control system may also advantageously determine a first orientation of the telescope with respect to the earth. For example, the system may determine the telescope's position with respect to the horizon and its pointing position. For example, if the telescope is located in the northern hemisphere, its orientation with respect to a level plane and magnetic north may be approximately determined. Given the date, time and location of the telescope with respect to the earth, the telescope control system can move the telescope from its initial orientation toward a celestial object having known celestial coordinates, such as an alignment star, group of alignment stars, alignment area, or the like. In certain embodiments, a user provides the date, time and location information. In other embodiments, a host system or peripheral device may advantageously provide at least one of the date information, the time information and the location information. Using this approximate knowledge of the surrounding sky, the telescope control system may image the region for alignment stars to complete the alignment as mentioned previously.

Once aligned, the telescope control system may advantageously slew the telescope to view any desired celestial object. Moreover, the telescope control system may advantageously suggest interesting or otherwise desired objects based on the time, date, and location of the telescope. The slewing accuracy to any selected celestial object can be improved by using image data to make fine adjustments to the final telescope position. If the celestial object is faint and not readily visible to the imager, a nearby start or other bright object can be used to obtain knowledge of the location of the fainter object.

Another operation facilitated by the closed-loop system is precise tracking of celestial objects. As the Earth rotates under the celestial sphere the objects appear to move. Tracking permits these objects appear to remain stationary to the observer using the telescope. Using the imager data, the telescope control system can detect minute errors in the tracking motion and make corrections. This permits the telescope control system to keep a selected celestial object in the same visual location for long periods of time.

In addition to pointing and tracking corrections, this embodiment will permit automated polar alignment of the telescope. Polar alignment is the act of making the main telescope axis parallel to the rotational axis of the Earth. Image data can be used by the telescope control system to tell the human operator or a motor system, how to adjust the axis to achieve the parallel position.

Another capability of the closed-loop telescope control system embodiment is to detect errors created by conditions in the telescope system or surrounding environment. In the telescope this would include but not be limited to gear qualities like backlash, periodic error and gear tooth deformities. Other mechanical sources of position error can also be detected like flexure of the structural members of the mount as weight shifts during movement of heavy parts to new positions. Errors created from the surrounding environment could include things like atmospheric refraction or turbulence. The ground under the telescope may deform as weight shifts. These movements which create position errors become visible in the image data supplied to the telescope control system. The few errors mentioned are not the only sources of error that can be corrected by the closed-loop telescope control system. Any source of error that can be detected in the data of the imager can be corrected by movement of the telescope.

A closed-loop telescope system can be placed at various points in the telescope to facilitate as much error detection and correction as is desirable considering other objectives such as cost, field installation or other factors. The imager communicates information about the observed objects allowing the telescope control system to respond accurately as required to correct the detected errors.

To facilitate an understanding of the disclosure, the remainder of the detailed description references the drawings, wherein like reference numbers are referenced with like numerals throughout. Moreover, the drawings show, by way of illustration, specific embodiments or processes in which the disclosure may be practiced. The present disclosure, however, may be practiced without the specific details or advantages or with certain alternative equivalent components and methods to those described herein. In other instances, well-known components and methods have not been described in detail so as not to unnecessarily obscure aspects of the present disclosure.

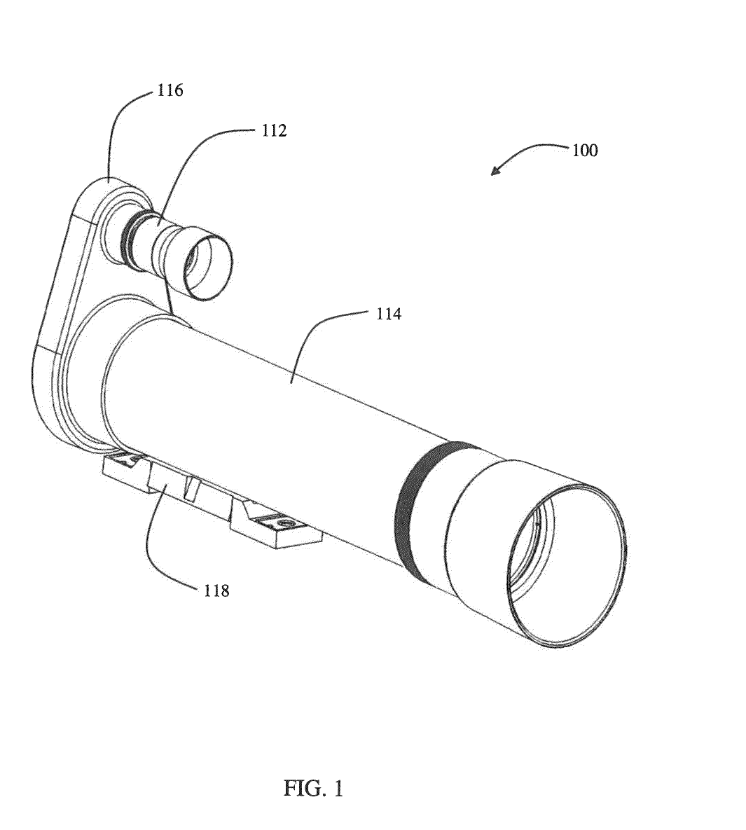

FIG. 1 is a perspective view illustrating an imager device 100 of a closed-loop telescope control according to the embodiment of the disclosure. The imager device 100 includes two optical channels 112, 114 to collect light from a subject and to focus the light at an image plane in the sensor housing 116. One optical channel 112 is a wide-field channel with roughly a 12 by 15 degree field of view. This wide-field is useful for pointing and alignment error detection. This field can be changes to make it larger or smaller as seems appropriate. The second optical channel 114 has a narrow-field of view of roughly a 1 by 1 degree. This narrow field channel can detect much smaller errors and is used primarily for high precision tracking or pointing and other sources of small errors. The two channels 112, 114, can be imagined as course and fine measurement options. These two channels can also be consolidated into a single channel or expanded to as many desired at the discretion of the artisan. Housing 116 contains electronic components and sensors at the image plane to be discussed later.

The imager device 100 embodiment here is designed as a complete unit and is mounted adjacent to or attached to a telescope Optical Tube Assembly (OTA) by a dovetail 118 bracket. The dovetail 118 is a universal connection mechanism for mounting the imager device 100 to any conventional telescope with the matching receptacle. By doing this StarLock can be easily added to existing telescopes and mounts while not eliminating the option to change OTA's or select a new OTA's in the future. Another imager configuration can be accomplished by placing the electronic sensors inside the telescope OTA and utilize the OTA optics for focusing the subject light. This would permit detection of error contributions from OTA component movements and correction of these additional sources of error.

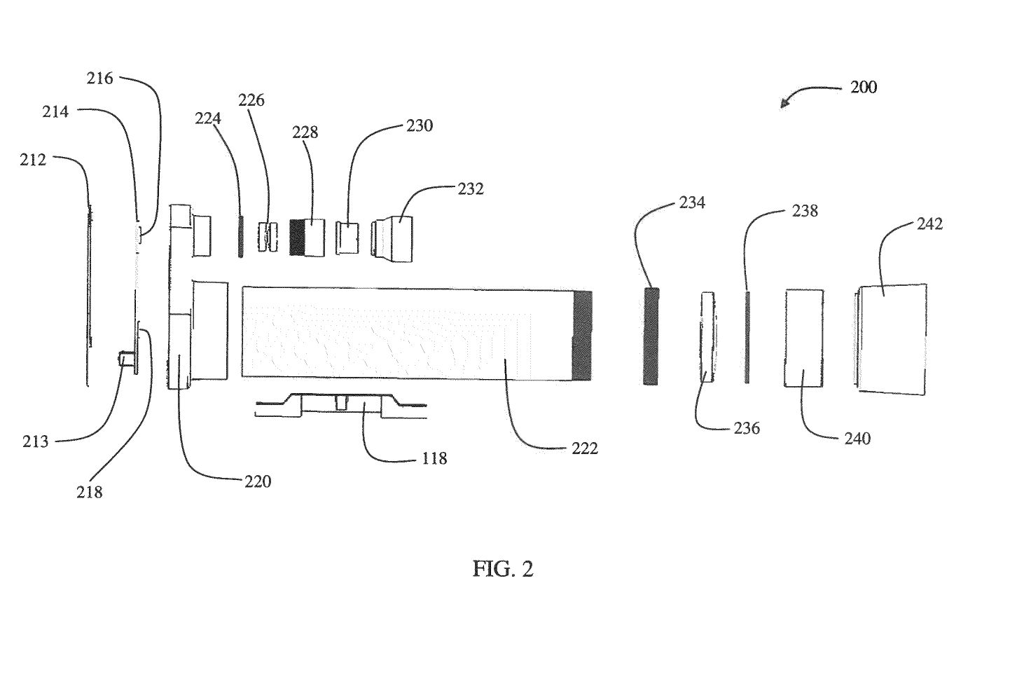

FIG. 2 is an exploded view illustrating an imager portion 200 of a closed-loop telescope control according to the embodiment of the disclosure. The housing 116 is comprised of the two structural pieces 212, 220 which capture the circuit board 214. The circuit board 214 contains two electronic imagers 216, 218 which capture light images from the wide-field channel 112 and the narrow-field channel 114 respectively. Cable connector 213 accepts a cable used to communicate image information to the closed-loop telescope control.

The wide-field channel 112 contains elements used to collect subject light and focus it on an electronic imager 216. Multiple lenses 226 are retained within tube 228 using spacer 230 and baffle 232. This wide-field assembly with lock ring 224 is screwed into the housing 220 until it focuses light from infinity on the electronic image sensor 216. Once focused the lock ring 224 is forced against housing 220 to prohibit further rotation and fix the focus position.

The narrow-field channel 114 contains elements used to collect subject light and focus it on an electronic imager 218. It is assembled in a similar fashion with the narrow-field tube 222 attached to the housing 220. The lens 236 is captured inside lens housing 240 with retainer 234. Lock ring 238 is screwed onto the narrow-field tube 222 followed by the lens assembly. The lens assembly 234, 236, 240 is screwed onto the narrow-field tube 222 until light from infinity is focused on electronic image sensor 218. Once focused the lock ring 238 is forced against lens housing 240 to prohibit further rotation and fix the focus position. The front baffle 242 is installed to shield the lens 236 from stray light and to prevent dew from forming. The dovetail bracket 118 is attached to the narrow-field tube 222 as the largest structural member of the imager assembly.

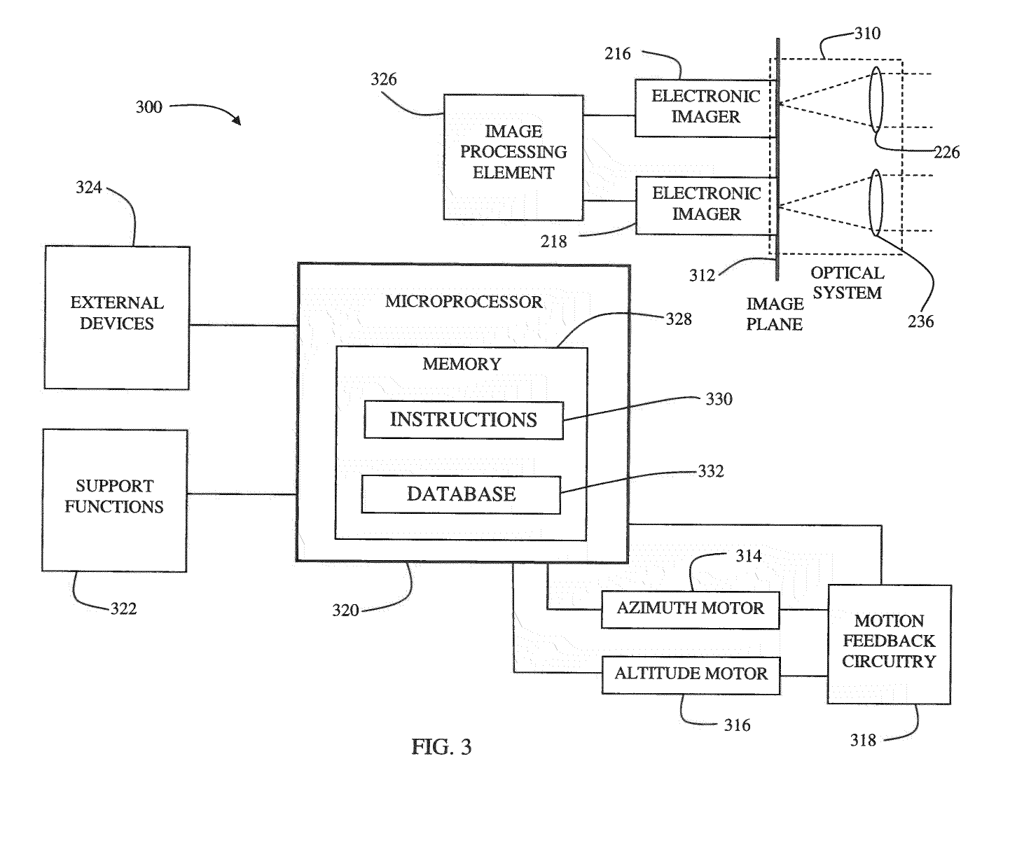

FIG. 3 is a block diagram illustrating a closed-loop telescope control system 300 according to an embodiment of the disclosure. The closed-loop telescope control system 300 has a microprocessor 320 which coordinates the multiple operations of the telescope. It includes a dual channel optical system 310 configured to collect light from a subject through optical elements 226, 236 and to focus the light at an image plane 312. The telescope control system 300 also includes electronic imagers 216, 218, an azimuth motor 314, an altitude motor 316, motion and position feedback sensors 318 and other sensor and support circuitry 322 as needed for additional functions. These additional functions might include internal time, position sensing with respect to gravity or a magnetic compass and so forth.

The electronic imagers 216, 218 are configured to generate an electronic image of the light from the subjects. Thus, the electronic imagers 216, 218 are positioned with respect to the image plane 312 so as to receive a focused optical image of the subject. In certain embodiments, the electronic imagers 216, 218 comprises, for example, a charge coupled device (CCD) camera, a complimentary metal oxide semiconductor (CMOS) image array, or the like. In this embodiment, the electronic imagers 216, 218 include local memory and a image processing element 326 to perform analysis of image data.

The image processing element 326 can analyze data from the electronic imagers 216, 218, and transmit the results to a microprocessor 320. The microprocessor 320 is configured to receive image data, provide control signals to the azimuth and altitude motors 314, 316, based on analysis of the data. The analysis may include, for example, identifying an alignment star or group of alignment stars and calculating how far to rotate the azimuth motor 314 and the altitude motor 316 to align the optical system 310, as described herein. The microprocessor 320 may be configured to interface with input devices (not shown) such as an Internet or other network connection, a wireless device, a mouse, a keypad or any device that allows an operator to enter data. The telescope control system 300 may also include output devices such as printers, displays or other devices or systems for generating hard or soft copies of images or other data. In certain embodiments, the telescope control system 300 is configured to interface with a television, such as a high-definition television, to display images from the electronic imagers 216, 218 thereon.

In an exemplary embodiment, the telescope control system 300 comprises a handheld device. In other embodiments, the telescope control system 300 may comprise, for example, a computer system, a personal computer, a laptop computer, a set top box for a television, a personal digital assistant (PDA), a Smartphone, a network, combinations of the same, or the like. The image processing element 326 may, for example, transmit the data to the microprocessor 320 wirelessly, through a direct electrical connection, or through a network connection. In certain embodiments, the image processing element 326 comprises a universal serial bus (USB) adapter. In other embodiments, the image processing element 326 comprises a wireless Ethernet adapter, Bluetooth, WiFi or other adapter.

In certain other embodiments, the telescope control system 320 comprises a controller housed with the optical system 310 and/or the electronic imagers 216, 218. For example, the telescope control system 300 may comprise one or more controllers, program logic, hardware, software, or other substrate configurations capable of representing data and instructions which operate as described herein or similar thereto. The telescope control system 300 may also comprise controller circuitry, processor circuitry, digital signal processors, general purpose single-chip or multi-chip microprocessors, combinations of the foregoing, or the like. In such embodiments, the image processing element 326 comprises a system bus or other electrical connections.

As shown in FIG. 3, in certain embodiments, the microprocessor 320 includes an internal memory device 328 comprising, for example, random access memory (RAM). The microprocessor 320 can also be coupled to an external memory device (not shown) comprising, for example, drives that accept hard and floppy disks, tape cassettes, CD-ROM or DVD-ROM. The internal memory device 328 or the external memory device, or both, comprise program instructions 330 for aligning the optical system 310, composing images of the subject and other functions as described herein.

In certain embodiments, the internal memory device 328 or the external memory device, or both, also comprise one or more databases 332 including at least one database of the celestial coordinates (expressed, for example, in right ascension and declination or other well known coordinate systems) of known celestial objects that might be of interest to an observer and/or that are useful to align the optical system 310. For example, the database 332 may include celestial coordinates and intensities of an alignment star or a group of alignment stars. The database 332 may also define a pattern made by at least one group of alignment stars. For example, the database 332 may include relationship information for the group of alignment stars such as brightness relative to one another, angular distances to one another, angles between each other, combinations of the foregoing, or the like. Other exemplary relationships between celestial objects are discussed herein. As discussed below, in certain embodiments, the microprocessor 320 is configured to automatically recognize a pattern of alignment stars and center the optical elements 226, 236 on a desired celestial object selected from the database 332. In certain embodiments, the telescope control system 320 also uses information from the database 332 to drive a focus motor (not shown) to automatically focus the optical system 310 on the desired celestial object.

The database 332 may also include, for example, a database of the geographical coordinates (latitude and longitude) of a large number of geographical landmarks. These landmarks might include known coordinates of cities and towns, geographic features such as mountains, and might also include the coordinates of any definable point on the earth's surface whose position is stable and geographically determinable. Thus, a user can estimate the position of the optical system 310 with respect to the earth by referencing a nearby geographical landmark in the database. As discussed below, in other embodiments, location information is provided automatically from a global positioning system (GPS) receiver. En certain embodiments, the database 332 is user accessible such that additional entries of particular interest to a user might be included.

As discussed in detail below, the microprocessor 320 controls the azimuth motor 314 and the altitude motor 316 to align the optical elements 226, 236 with the light from the subject. The azimuth motor 226 and the altitude motor 236 are configured to rotate the optical system 310 in two mutually orthogonal planes (e.g., azimuth and altitude). These orthogonal planes may be oriented in any position with reference to the surface of the Earth including a polar orientation (azimuth plane parallel to Earths rotational plane) as well as others. In certain embodiments, the azimuth motor 226 and the altitude motor 236 are each self-contained motor packages including, for example, a DC brush-type motor, an associated electronics package on a printed circuit board, and a drive and reduction gear assembly. An artisan will recognize from the disclosure herein that other known motor and/or servo systems can also be used. In certain embodiments, the azimuth motor 226 and the altitude motor 236 are coupled to motion feedback circuitry 318, such as an optical encoder or the like. The motion feedback circuitry 318 measures the actual travel of the optical system 310 in both planes. Thus, the position of each axis (and the telescope aspect) is determinable with respect to an initial position.

In certain embodiments, the telescope control system 300 automatically determines an orientation of the optical elements 226, 236 using data received from other sensors 322 such as a level sensor and the electronic compass (not shown). During an initial alignment, the telescope control system 300 determines the orientation of the optical elements 226, 236 with respect to the horizon based on one or more signals received from a level sensor. This becomes the initial altitude position. The host system also determines the orientation of the optical elements 226, 236 with respect to north (e.g., if in the northern hemisphere) or south (e.g., if in the southern hemisphere) based on one or more signals received from an electronic compass. This becomes the initial azimuth position.

In certain embodiments, the microprocessor 320 is configured to interface with additional sensors 322 to align the optical system 310. The additional sensors 322 may include, for example, a GPS receiver configured to accurately indicate the longitude and latitude of the telescope control system 300 and/or a clock configured to accurately indicate the date and time. It should also be understood that a GPS receiver is able to provide timing signals which can function as precision timing reference signals. Thus, coupling a GPS receiver to the telescope control system 300 provides not only coordinated timing data but also user position data from a single device. Thus, these parameters may advantageously be determined without manual entry.

In addition, or in other embodiments, the other sensors 322 may include, for example, an electronic focusing system, a laser configured to emit laser light in the direction of the subject being observed, an audio input and/or output device, a joystick or other controller configured to manually drive the azimuth motor 314 and the altitude motor 316, a speech recognition module along with an associated audio output module, an automatic alignment tool (tube leveler and/or axis planarizer), a photometer, an autoguider, a reticle illuminator, a cartridge reader station (e.g., for courseware, revisions, new languages, object libraries, data storage, or the like), and/or another imager or camera that is not coupled to the optical system 310 and that can be used, for example, to view terrestrial objects in the vicinity of the telescope control system 300. An artisan will recognize that some or all of the support functions 322 may be external accessories or may be housed with the optical system 310 and/or the electronic imagers 216, 218. An artisan will also recognize that some or all of the support functions 322 may be coupled directly to the microprocessor 320 or other portions of the telescope control system 300.

Although the microprocessor 320 specifically and the telescope control system 300 in general are disclosed with reference to their preferred and alternative embodiments, the disclosure is not limited thereby. Rather, an artisan will recognize from the disclosure herein a wide number of alternatives for control and telescope systems 320, 300 including alternative devices performing a portion of, one of, or combinations of the functions and alternative functions disclosed herein.

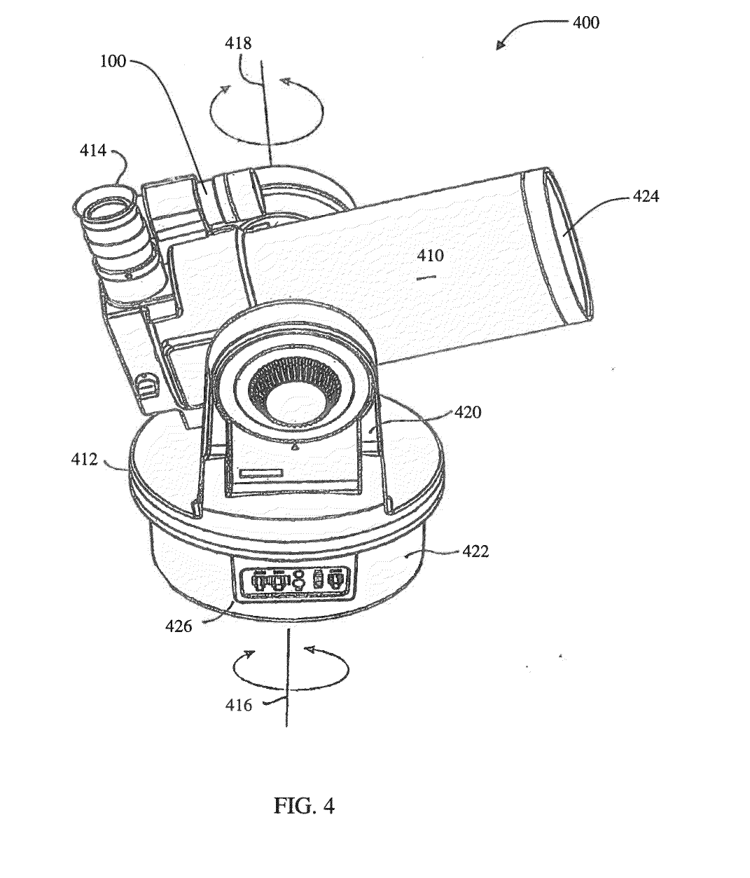

FIG. 4 is a perspective view of an exemplary telescope 400 usable by the telescope control system 300 shown in FIG. 3, according to an embodiment of the disclosure. The telescope 400 comprises a telescope tube 410 and a mount 412 configured to support and move the telescope tube 410. The telescope tube 410 houses an optical system that collects light from distant objects through the optical elements 424 inside tube 410 and focuses the light onto an image plane. In certain embodiments, the electronic imagers 216, 218 is located within the telescope tube 210 at an image plane. However, as shown in FIG. 4, and in other embodiments, the electronic imager or imagers 216, 218 in the imager device 100 are attached to the exterior of the telescope tube 410 in a separate housing. This attachment point allows the imager device to have a similar and overlapping field of view with the optical elements 424 inside telescope tube 410. In certain such embodiments, a single imager may be used with an adjustable lens to selectively provide additional optical magnification or reduction of the image provided at the image plane 312. Thus, a user or the image processing element 326 can change the field of view as desired.

The telescope tube 410 is supported by the mount 412 which facilitates movement of the telescope tube 410 about two orthogonal axes, an azimuth axis 416 and an altitude axis 418. The axes 416, 418 of the mount 412, in combination, define a gimbaled support for the telescope tube 410 enabling it to pivot about the azimuth axis 416 in a horizontal plane and, independently, to pivot about the altitude axis 418 through a vertical plane. In certain embodiments, a user may not level the mount 412 with respect to the earth. For example, the mount 412 may be tilted forward or backward with respect to the direction of the telescope tube 410. The mount may also be tipped in a perpendicular direction to the telescope tube 410. In certain embodiments, one or more signals from a level sensor are used to measure the tip and tilt of the mount 412 with respect to a level position.

It should be noted that the telescope tube 410 is configured as a reflecting-type telescope, particularly a Maksutov-Cassegrain telescope. In this regard, the form of the telescope's optical system is not particularly relevant to practice of principles of the present disclosure. Thus, even though depicted as a reflector, the telescope 400 of the present disclosure is suitable for use with refractor-type telescope optical systems. The specific optical systems used might be Newtonian, Schmidt-Cassegrain, Maksutov-Cassegrain, or any other conventional reflecting or refracting optical system configured for telescopic use. For example, the telescope 400 may comprise a dome telescope such as are generally operated by professional astronomers.

Although not shown in FIG. 4, the telescope 400 includes the azimuth motor 314 and the altitude motor 316 discussed above. The azimuth motor 314 and the altitude motor 316 are respectively coupled to the azimuth axis 416 and altitude axis 418 so as to pivotally move the telescope tube 410 about the corresponding axis. In certain embodiments, the altitude motor 316 is disposed within a vertically positioned fork arm 420 of the mount 412 and the azimuth motor 314 is disposed within a horizontally positioned base 422 of the mount 412. Motor wiring is accommodated internal to the structure of the mount 412 (including the fork arm 420 and the base 422) and the system's electronic components are packaged accordingly.

Although the exemplary telescope 400 is disclosed with reference to this and alternative embodiments, the disclosure is not limited thereby. Rather, an artisan will recognize from the disclosure herein a wide number of alternatives for the telescope, including optical viewing devices including academic or governmental installations to personal magnification devices, dome-mounted devices, all manner of telescope devices, or the like.

With the basic system components described in FIG. 1, FIG. 2, FIG. 3 and FIG. 4 automatic telescope operations can be performed by using appropriate instructions 330 in the microprocessor 320 based on sensor and image data. These telescope operations might include automatic celestial alignment of a telescope, polar alignment of a telescope mount, high precision pointing toward celestial objects, precision tracking of celestial objects and measurements of mechanical characteristics of the telescope system and surroundings.

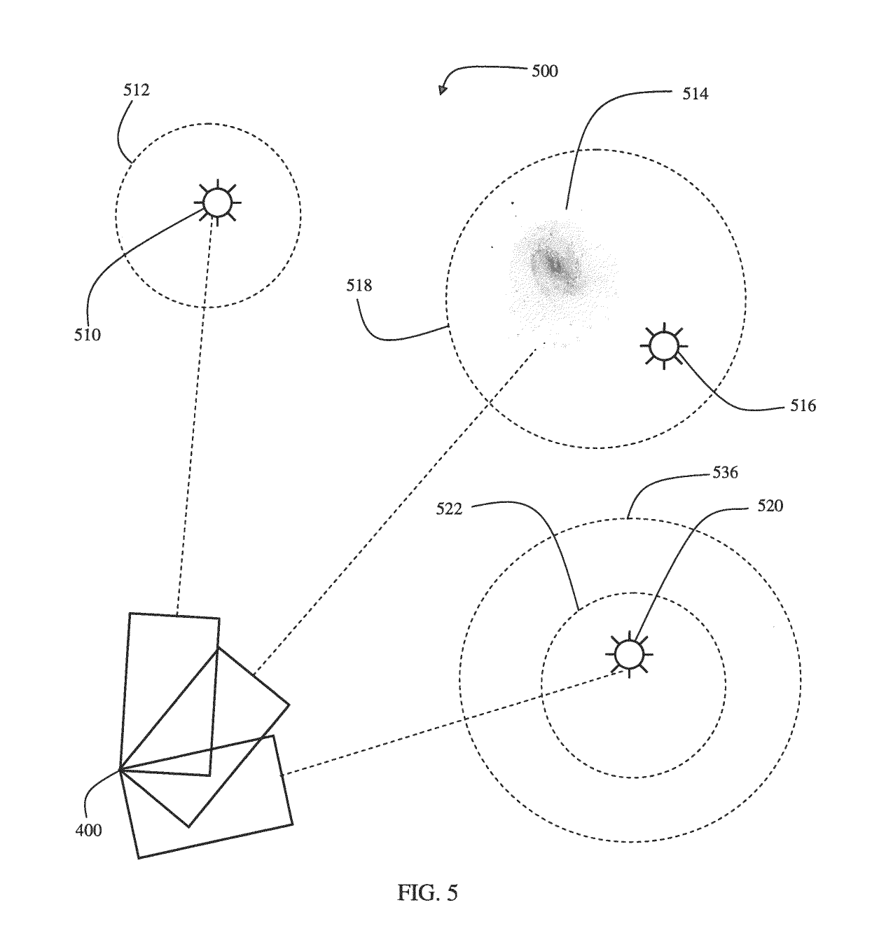

FIG. 5 is an exemplary graphical representation of a celestial hemisphere 500 used in object identification and observational processes according to an embodiment of the disclosure. This representation shows typical objects observed in a darkened celestial hemisphere 500 (night sky) greatly simplified in variety and in quantity. These objects include bright reference stars 510, 516, 520 which are also called alignment stars. They very bright and easily identified when compared to surrounding faint stars. Faint objects 514 like some stars, galaxies, nebula, clusters and the like, can be so faint as to be visible only with a telescope and possibly require very sensitive imagers to be detected with a telescope. The faint objects 514 are likely of most interest to observers because of their variety and distinctive characteristics.

Typically, the first important operation of a telescope control system 300 is to establish a relationship between the axes 416, 418 of a telescope and the celestial hemisphere. Once this relationship is established, called alignment, mathematical models can be used by the microprocessor 320 to instruct telescope motors move the telescope to point at any object in the database 332. Using the closed-loop capabilities of the telescope control system 300, a fully automated alignment process is possible.

An exemplary self-alignment process is usable by a telescope system, such as the telescope system 400 of FIG. 4. The alignment process comprises, in short, receiving or determining a current time and an approximate location of a telescope, selecting an alignment area, leveling or virtually leveling the telescope (determining the orientation of the telescope with respect to earth), slewing the telescope toward an approximated location of the alignment area, acquiring an electronic image of a portion of the sky corresponding to the approximated location, identifying a center of a current field of view, and mapping the celestial coordinates of the center of a current field of view to the telescope's coordinate system. An artisan will recognize from the disclosure herein a wide variety of alternate mapping procedures, including for example, identifying a particular alignment star and using it to create the appropriate mapping, identifying a particular pattern of stars and using that information to create the appropriate mapping, identifying a sidereal drift and using that information to create the appropriate mapping, or the like.

In more detail, the self-alignment includes receiving or determining a current time and an approximate location of a telescope. The current time includes, for example, the current date. As discussed above, in certain embodiments, this information is provided by a GPS receiver. In other embodiments, the current time and/or approximate location of the telescope may be received directly from a user, other peripheral devices, or the like. Next alignment area is selected to orient a telescope with the celestial coordinate system. In certain embodiments, the alignment area is selected from viewable portions of the sky based on the current time and the approximate location of the telescope with respect to the earth. In addition, or in other embodiments, the alignment area is selected based at least in part on a celestial object selected by a user for viewing. For example, the alignment area may be selected because it is near the celestial object selected for imaging by the user. In other embodiments, the telescope is simply slewed toward the sky to a location above an approximation of potential horizon interference (such as, for example, above approximately 30.degrees over the horizon) and sufficiently below an approximate vertical to generate accurate alignment data (such as, for example, below 75.degrees over the horizon).

In certain embodiments, the selected alignment area includes stars with known celestial coordinates and relationships. For example, an alignment area may include an alignment star and one or more additional stars in the vicinity of the alignment star that help identify the alignment star. For example, in certain embodiments, the alignment star is associated with one or more other stars that form a recognizable pattern. Data related to such patterns may be stored and used to later recognize the patterns. The data may include, for example, differences in magnitude or brightness between a group of stars in the alignment area, angular distances between the group of stars, a shape formed by the group of stars, angles formed between the stars in the group, combinations of the foregoing, and the like.

In certain embodiments, the telescope is in an unknown orientation with respect to the earth. Thus, the telescope may be tilted in a first direction and tipped in a second direction such that the rotation axes of the telescope form angles with the horizon. The user may also set the telescope on the ground or on the tripod without pointing the telescope at any particular object (e.g., the north star or another know celestial object) or in a known direction (e.g., with respect to the north pole or the south pole). As discussed in greater detail below, in certain embodiments, the telescope control system is capable of determining the tip and tilt without further input from the user. The telescope control system 300 is also capable of determining the direction in which the telescope is pointing, for example, with respect to north or south. Thus, it is possible to approximately determine the orientation of the telescope with respect to the earth.

When the level measurement, the compass direction measurements, the current time, and the location information are sufficiently accurate, then the alignment is complete and the telescope control system 300 may advantageously slew to any set of celestial coordinates. However, in certain embodiments, such measurements and information include approximations and are not sufficiently accurate so as to allow the telescope control system to center the telescope's field of view on a selected celestial object.

Therefore, the self-alignment process includes slewing the telescope toward an approximated location of an alignment area 512. As mentioned in the foregoing, the alignment area 512 may be a specific alignment star 510 or group of stars, or may simply be a location above an approximation of potential horizon interference and sufficiently below an approximate vertical.

The self-alignment process includes acquiring an electronic image of a portion of the sky corresponding to the approximated location. The electronic image, such as a digital photograph or the like, includes image data corresponding to the alignment area including, for example, stars in the vicinity of the alignment star 510. The process includes identifying one or more stars in the electronic image. An artisan will recognize from the disclosure herein that other alignment mapping could be used, such as, for example, locating the celestial position of a predetermined star or pattern of stars, an error from the predetermined star or pattern of stars, combinations of the same or the like. As discussed in detail below, in certain embodiments, the one or more stars are identified by comparing relative magnitudes among the stars and/or angular distances between the stars with known relative magnitudes and/or angular distances (not shown).

Once a point or the current center of the telescope's field of view has been identified, the self-alignment process includes mapping the celestial coordinates of at least one of the identified stars to the telescope's coordinate system, as discussed above. Thus, the alignment is complete and the telescope can be slewed to the celestial coordinates of any desired visible celestial object.

However, in certain embodiments, it is advantageous to increase the accuracy of the alignment by identifying alignment star in a different alignment area. For example, one iteration of the alignment above may provide, for example, an alignment accuracy on the order of approximately one arcminute. However, in certain embodiments, it is desirable to have an alignment accuracy on the order of approximately one or more arcseconds. To increase the alignment accuracy according to certain embodiments, the telescope control system 300 repeats the acquisition of a second alignment star 520 in a different region of the celestial hemisphere 500 and uses this to remove any remaining error in the alignment. For example, the telescope control system 300 selects a new alignment area 522. In an embodiment, the new alignment area is preferably of a longer arc length from the original alignment area. For example, long arc lengths between the previous alignment area and the new alignment area generally provide increased accuracy as compared to shorter arc lengths. While the new alignment area according to certain embodiments is closer than approximately 130 degrees from the previous alignment area, and according to other embodiments is within the same field of view of the telescope as the previous alignment area, in certain embodiments the new alignment area is advantageously selected at an arc length of approximately 130 degrees from the previous alignment area.

While certain embodiments for aligning telescopes have been described above, other embodiments within the scope of the disclosure will occur to those skilled in the art. For example, in certain embodiments, telescope alignment can be achieved by measuring the drift of one or more stars as taught in U.S. patent application Ser. No. 09/771,385, filed Jan. 26, 2001, by Baun et al. which is not included here for brevity.

Another automatic operation of a telescope control system 300 is to improve the pointing accuracy of the telescope 400 after it is aligned and when it slews to an object selected from the database 332. The pointing accuracy of a slew will be less than perfect due to many factors discuss in the prior art section of this disclosure. Before attempting to improve pointing accuracy the user needs to indicate a precise location where he expects the telescope control system 300 to place objects after a slew. This expected position can vary and be changed to meet the requirements of present circumstances.

The expected position of an object is predetermined by the telescope operator. It is a specific position at the focal plane in his telescope tube 410 created by the optical elements 424 for the object. This could be the center of an eyepiece 414 used by the observer, the center of a very small image sensor used in a camera, a slit in a spectrometer or the like. There is no restriction on the selection of the expected position, it can be any location the meets the current needs of the operator. Selecting this expected position is initialized by the operator selecting, for example, alignment star 512 and placing the image at the expected position on the focal plane. The operator does this using an external device 324 like a handbox, host computer or the like. Once the star is in the expected position, the operator indicates to the telescope control system 300 that all objects should be placed in this position when slewing to that object. This procedure instructs the telescope control system 300 how to interpret images from the optical system 310 to locate the expect position. This expected position can be changed as requested by the operator. This might be required when a new optical accessory is added to the telescope 400 like a new eyepiece 414 or a camera system (not shown).

After the expected position is defined, the telescope control system 300 is prepared to make very accurate movements to any object selected by the operator. When an object is selected for viewing, the first decision required by the telescope control system 300 is to determine the characteristics of the target object using database 332. If the target object is a bright reference or alignment star 510, 516, 520 then a simple method is employed. Alignment stars 510, 516, 520 are limited in number and not confused with other objects nearby. If the target is a faint object 514 then a second method is used which requires additional steps. Any object that is not classified as an alignment star will be treated as a faint object 514.

The simplest pointing improvement method is one whose target object is one of the bright reference or alignment stars 510, 516, 520. These are readily visible and unique without nearby comparable objects. These alignment stars are initially selected for their unique properties. Additional alignment stars may be added to the database for some property which makes them uniquely identifiable. Some of these properties were discussed in the section on identifying alignment area celestial coordinates. The attribute of brightness and lack of companions is not the only quality to be considered. Like a fingerprint many qualities like color, patterns, angles with companions and the like, can uniquely identify an object for this simple method.

To improve the pointing accuracy after an initial movement to an object, the telescope control system 300 will image the field of view of the current position using the wide-field imager 216. The field of view of wide-field imager 216 is large enough to include the intended object like alignment star 520 with the anticipated inaccuracy of the original slew. The wide-field of view 536 should not be so large as to capture another similar object like alignment star 516. An earlier description of this field was 12 by 15 degrees. This field of view is not special to this operation and can be select by an artisan to match whatever goals are desirable to an implementation. Once the image has been analyzed and the alignment star 520 detected, the telescope control system 300 can determine the difference between the present position and the expected position. The telescope control system 300 will command the azimuth motor 314 and the altitude motor 316 to move the required distance to place the object at the expected position. This pattern of moving the telescope 400 and imaging, and determining the error can be done one or multiple times until the desired accuracy is achieved. In addition to using the wide-field imager 216, the telescope control system 320 can use the narrow-field imager 218 with a smaller field of view 522 and higher resolution. The telescope control system 300 with even higher resolution images will give higher accuracies by fine motor movements.

A second process of pointing accuracy is used when faint objects 514 are involved. These can include distant or small stars and faint features like nebula or distant galaxies which can be invisible to the naked eye observer. Many of these celestial objects may only be detectable by very sensitive electronic imagers or film after long exposures. To point at these faint objects 514, the telescope control system selects a nearby bright alignment star 516 and moves the telescope 400 to point at the alignment star 516. The telescope control system 300 will image the field of view of the current position using the wide-field imager 216. The field of view of wide-field imager 216 is large enough to include the intended alignment star 516 with the anticipated inaccuracy of the original slew. Once the image has been analyzed and the alignment star 516 detected, the telescope control system 300 can determine the difference between the present position and the expected position. The telescope control system 300 will command the azimuth motor 314 and the altitude motor 316 to move a short distance to place the requested faint object 514 at the expected position based on the error measured for the nearby alignment star 516. The short movement to the object anticipates very small additional error across the short distance.

Telescope tracking is another area that which is greatly improved by using the capabilities of a closed-loop telescope control 300. Tracking is an activity where the telescope motors move slowly and precisely to match the apparent movement of celestial objects. This movement happens due to the rotation of the Earth. The motor movements can be very simple if the telescope is polar aligned or very complex involving continuously changing motor speeds in both axes in nonpolar modes. As has been mentioned in the prior art portion of this disclosure, there are many sources of error that can affect tracking accuracy.

Tracking accuracy requires much greater accuracy than the previous pointing operations. While operators doing direct visual observing will not detect small variations, sensitive cameras taking long exposure will have blurred images if tracking accuracy is nor precise and consistent. When a telescope 400 is used to make very long exposure with a sensitive camera attached, even the smallest inaccuracies will impact the quality of the captured image. For these reasons, the telescope control system 300 uses the narrow-field imager 218 in operations to improve tracking accuracy.

First the operator selects an object to be observed and the microprocessor 320 is instructed to slew to that object. Once the selected object has been placed in the expected position, the microprocessor 320 commands the azimuth motor 314 and altitude motor 316 to move at the rates necessary to match the apparent movement of the selected object. To confirm the telescope 400 is moving at the requested rate an image from the narrow-field imager 218 is taken and information provided to the microprocessor 320. The microprocessor 320 selects a star in the field of view of the narrow-field imager 218 to use as a reference. This star may be a bright alignment star 516 or any other star that meets certain criterion for use in this operation. Because the narrow-field imager 218 imaging area is small (perhaps 1 degree square) it is unlikely that an alignment star 516 is captured. Therefore, for guiding purposes, the microprocessor 320 will find the brightest available star within the field that can be used. Because the microprocessor 320 expects some small movements a guidestar is selected based on qualities that make it a good reference point for measuring small displacements. The characteristics vary with many situations including visual conditions, weather conditions, the area of the sky selected and the like.

Once a guidestar has been selected, the microprocessor 320 will begin a regular cadence of taking images using the narrow-field imager 316 and analyzing the image data to measure small movements in the guidestar. Based on guidestar movements in the image from the original position, the microprocessor 320 will change the movement rates of the azimuth motor 314 and or the altitude motor 316 to correct the tracking error. Because these corrections are detected in the telescope control system 300 and motor changes initiated immediately a more accurate control is possible by comparison to more indirect methods.

While certain embodiments of the disclosures have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

### CONCLUSION, RAMIFICATION AND SCOPE

The reader will see that closed-loop telescope operation is now possible using the telescope control system described in this disclosure. The connection has been made between the observable objects in the celestial hemisphere and the control system that moves the telescope to observe them. Indirect methods which include errors are eliminated with resulting improvement in pointing accuracy, tracking accuracy and assisted operations like celestial alignment, polar alignment and measurements in mechanical and environmental characteristics.

What is claimed is:

1. A system for accurately viewing celestial objects, the system comprising:
a microprocessor;
a telescope configured to determine with minimal user intervention an approximate orientation of a telescope coordinate system with respect to a celestial coordinate system; and
imaging devices configured to be connected to the telescope, wherein the microprocessor is configured to identify particular stars in an electronic image acquired by the imaging devices and to update the approximate orientation or motion based at least in part on the identified star, wherein the microprocessor is configured to align the telescope with a celestial object, and wherein the microprocessor is configured to accurately place the celestial object in a specified focal plane location and maintain said location.

2. The system of claim 1, wherein the imaging device has an overlapping field of view with the telescope field of view.

3. The system of claim 1, wherein the imaging device comprises a single imager with adjustable fields of view.

4. The system of claim 1, wherein the microprocessor is further configured to change one or more optical characteristics of the imaging device.

5. The system of claim 4, wherein the imager measures internal sensor noise by blocking all incoming light.

6. The system of claim 1, wherein the imaging device is configured to acquire images through the telescope.

7. The system of claim 1, wherein the microprocessor uses image data measurements in servo motor control processes.

8. The system of claim 1, wherein the microprocessor anticipates motion changes based on previous image data patterns.

9. The system of claim 1, wherein the microprocessor is further configured to facilitate telescope polar alignment.

10. The system of claim 1, wherein the microprocessor is further configured to change one or more optical characteristics of the telescope.

11. A method for accurately viewing celestial objects, the method comprising:
receiving the identity of a celestial object;
determining with minimal user intervention an approximate orientation of a coordinate system of a telescope with respect to a celestial coordinate system;
receiving an alignment electronic image;
identifying one or more stars in the alignment electronic image;
based at least in part on the identity of the one or more stars in the alignment electronic image, updating the approximate orientation of the telescope coordinate system;
slewing the telescope to the celestial coordinates of the celestial object; accurately placing the celestial object in a specified focal plane location and maintain said location.

12. The method of claim 11, wherein the identity of the celestial object is received from a user controlled device.

13. The method of claim 11, wherein at least one of the alignment electronic images is received from an imaging device configured to acquire images through the telescope.

14. The method of claim 13, wherein the alignment electronic image is received through a wireless network connection.
